(19) United States
(12) Patent Application Publication
(10) Pub. No.: US 2003/0204507 A1
(43) Pub. Date: Oct. 30, 2003

(54) Classification of rare events with high reliability

(76) Inventors: Jonathan Qiang Li, Redwood City, CA (US); David R. Smith, San Jose, CA (US); Lee A. Barford, San Jose, CA (US); John M. Heumann, Loveland, CO (US)

Correspondence Address: AGILENT TECHNOLOGIES, INC., Legal Department, DL429, Intellectual Property Administration, P. O. Box 7599, Loveland, CO, 80537-0599, US

(21) Appl. No.: 10/132,626

(22) Filed: Apr. 25, 2002

(51) Int. Cl. G06N 5/00

(52) U.S. Cl. 707/100

(57) ABSTRACT

Hierarchical classification of samples. First stage classification identifies most members of the majority class and removes them from further consideration. Second stage classification then focuses on discriminating between the minority class and the greatly reduced number of majority class samples lying near the decision boundary.

### BACKGROUND OF THE INVENTION

1. Field of the Invention

The present invention pertains to techniques for constructing and training classification systems for use with highly imbalanced data sets, for example those used in medical diagnosis, knowledge discovery, automated inspection, and automated fault detection.

2. Art Background

Classification systems are tasked with identifying members of one or more classes. They are used in a wide variety of applications, including medical diagnosis, knowledge discovery, automated inspection such as in manufacturing inspection or in X-ray baggage screening systems, and automated fault detection. In a 2-class case, input data is gathered and passed to a classifier which maps the input data onto {0,1}, e.g. either good or bad. Many issues arise in the construction and training of classification systems.

A common problem faced by classification systems is that the input data are highly imbalanced, with the number of members in one class far outweighing the number of members of the other class or classes. When used in systems such as automated airport baggage inspection, or automated inspection of solder joints in electronics manufacturing, “good” events far outnumber “bad” events. Such systems require very high sensitivity, as the cost of an escape, i.e. passing a “bad” event, can be devastating. Simultaneously, false positives, i.e. identifying “good” events as “bad” can also be problematic.

As an example showing the need for better classification tools, the electronics industry commonly uses automated inspection of solder joints while manufacturing printed circuit boards. Solder joints may be formed with a defect rate of only 500 parts per million opportunities (DPMO or PPM). In some cases defect rates may be as low as 25 to 50 PPM. Despite these low defect rates, final assemblies are sufficiently complex that multiple defects typically occur in the final product.

A large printed circuit board may contain 50,000 joints, for example, so that even at 500 PPM, 25 defective solder joints would be expected on an average board. Moreover, these final assemblies are often high-value, high-cost products which may be used in high-reliability applications. As a result, it is essential to detect and repair all defects which impair either functionality or reliability. Automated inspection is typically used as one tool for this purpose. In automated inspection of solder joints, as in baggage inspection, X-ray imaging produces input data passed to the classification system.

Very high defect sensitivity is thus required. However, defects are vastly outnumbered by good samples, making the inspection task more difficult. In a 500 PPM printed circuit board manufacturing process, good joints will outnumber bad joints by 2000 to 1. As a result, misidentifying even a small fraction of the good samples as defective can swamp the true defects and render the testing process ineffective.

Additionally, the economic cost of an escape (missing a defect, also known as a type II error) may be different than the economic cost of a false alarm (mistakenly calling a good sample bad, also known as a type I error). Moreover, both relative costs and frequencies may change over time or between applications, so the ability to easily adjust the balance between sensitivity (defined as 1—escape rate ) and the false alarm rate is required. Finally, an ability to quickly and easily incorporate new samples (i.e. to learn from mistakes) is highly desirable.

Classical pattern recognition provides many techniques for identification of defective samples, and some techniques permit adjusting relative frequencies of the classes as well as variable costs for different types of misclassification. Unfortunately, many of these techniques break down as the ratio between the sample sizes of good and defective objects in the training data becomes very large. Accuracy, computational requirements, or both typically suffer as the data become highly imbalanced.

### SUMMARY OF THE INVENTION

Classification of highly imbalanced input samples is performed in a hierarchical manner. The first stages of classification remove as many members of the majority class as possible. Second stage classification discriminates between minority class members and the majority class members which pass the first stage(s). Additionally, the hierarchical classifier contains a single-knob threshold where moving the threshold generates predictable trade-offs between the sensitivity and false alarm rate.

### BRIEF DESCRIPTION OF THE DRAWINGS

The present invention is described with respect to particular exemplary embodiments thereof and reference is made to the drawings in which:

FIG. 1 is a flowchart of a hierarchical classifier.

### DETAILED DESCRIPTION

While the approach described herein is applicable to classification systems used in a wide variety of arts, including but not limited to medical diagnosis, knowledge discovery, baggage screening, and fault detection, examples are given in the field of industrial inspection.

Although statistical classification has been extensively studied, no method works effectively for highly imbalanced data where the ratio of sample set sizes between the majority class, for example good solder joints, and the minority class, for example bad solder joints, becomes very high. Computational requirements (time or memory) required for training or classification or both often become prohibitive with highly imbalanced data. Additionally, conventional approaches are often unable to achieve the required sensitivity without excessive false alarms.

A typical setup for classification is as follows.

Let

$$y = \{ \begin{matrix}1 & defective \\ 0 & not defective\end{matrix} \}$$

be the class variable. Also let

x=(xₗ, . . . , xₖ)^{T}

be a vector of measured features. While the present invention is illustrated in terms of 2-class systems, those in the art will readily recognize these techniques as equally applicable to multi-class cases. A trained classifier can be represented as:

\hat{ƒ}(x|XT₁, XT₂, . . . , XT_{N})

where XT₁, . . . , XT_{N} are the training data and the classifier \hat{ƒ} is a mapping from x onto {0,1}. A common measure of performance is the overall misclassification or error rate. An estimate of this measure may be obtained by computing error rate E on a set of validation data XV₁, . . . ,XV_{M}:

$$E = \frac{1}{M} {\sum }_{i = 1}^{M} 1 \{ {y}_{i} \neq {f}_{i} \} \qquad ( 1 )$$

where ƒᵢ=\hat{ƒ}(XVᵢ|XT₁, XT₂, . . . , XT_{N}) are the outputs from the trained classifier for each validation data point, and 1{condition} is an indicator function for the purpose of counting(equaling 1 if “condition” is true, 0 otherwise, a convention we will use throughout the document). On highly imbalanced data, naïve use of this measure often results in unacceptable performance. This is understandable since, in the extreme case, simply calling everything “good” (i.e. a member of the majority class) yields a low misclassification rate. As a result, classifiers trained in this manner on highly imbalanced data tend to call samples good absent compelling (and often unobtainable) evidence to the contrary.

A partial and widely used solution to this problem is to recognize that escapes and false alarms may have unequal impacts. Formulating the problem in terms of “cost” instead of “error” E, let Cₑ and C_{f} be the cost of an escape or a false alarm, respectively. An appropriate performance measure then becomes the average cost C:

$$C = \frac{1}{M} [ {C}_{e} {\sum }_{i = 1}^{M} 1 \{ {y}_{i} > {f}_{i} \} + {C}_{f} {\sum }_{i = 1}^{M} 1 \{ {y}_{i} < {f}_{i} \} ] , \qquad ( 2 )$$

Additionally, training (and, in some cases, classification) time can become unreasonably long due to the large number of “good” samples which must be processed for each representative of “bad” class. Subsampling from the “good” training set may be used to keep the computational requirements manageable, but the operating parameters of the trained classifier must then be carefully adjusted for optimal performance under the more highly imbalanced conditions which will be encountered during deployment.

Even with such formulations, accuracy of the trained classifier is often found to be inadequate when the data are noisy and/or highly imbalanced. Partial explanations for this behavior are known and described, for example, in Gary M. Weiss and Foster Provost, “The Effect of Class Distribution on Classifier Learning”, Technical Report ML-TR-43, Rutgers University Department of Computer Science, January 2001, and in Miroslav Kubat and Stan Matwin, “Addressing the Curse of Imbalanced Training Sets: One-Sided Selection”, Proceedings of the 14^{th} International Conference on Machine Learning, pages 179-186, 1997.

Difficulty in obtaining sufficient training samples of the “bad” class as well as the highly imbalanced nature of the training data are intrinsic phenomena in the industrial inspection of rare defects, and in many other application areas. Previously known techniques do not provide a satisfactory solution for these applications.

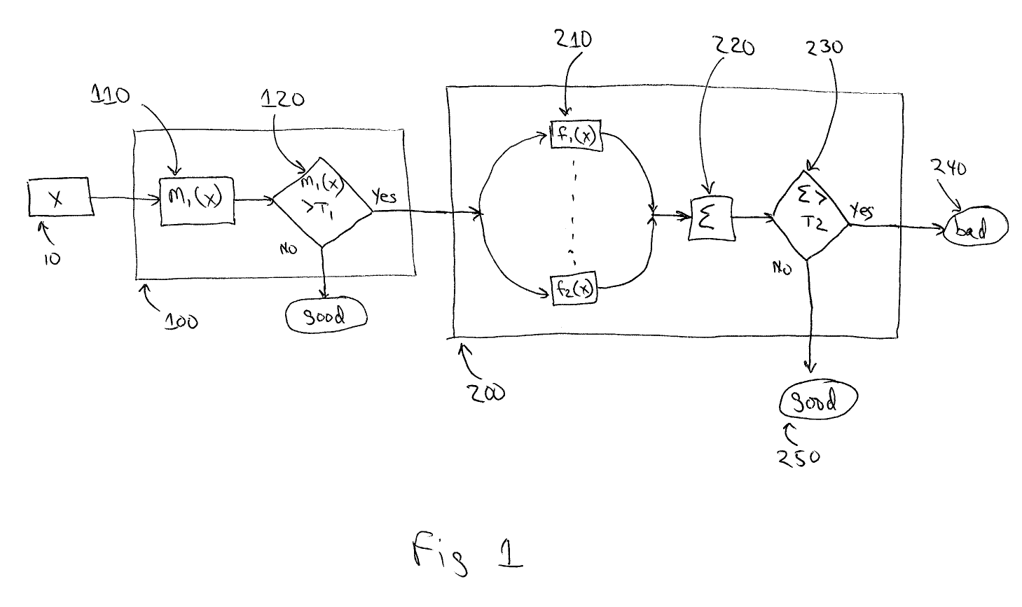

According to the present invention, a novel type of hierarchical classification is used to accurately and rapidly process highly imbalanced data. An embodiment is shown as FIG. 1. Input data 10 is passed to first-stage classification 100 which identifies most members of the majority class and removes them from further consideration. Second-stage classification 200 then focuses on discriminating between the minority class and the greatly reduced number of majority class samples lying near the decision boundary.

A hierarchical classifier according to the present invention is constructed according to the following steps.

First, the first-stage classifier is trained. Let the training data be XGₙ, n=1,2, . . . ,N_{G} and XBₙ, n=1,2, . . . ,N_{B}, where XG are from the majority class (for example, good solder joints), and XB are from the minority class (for example, bad solder joints).

The key in the first stage classification is to find a simple model based on the XG, the data from the majority class, and then form a statistical test based on the model. The critical value (threshold) for the statistical test is chosen to make sure all samples that are sufficiently different from the typical majority data are selected) by the test.

Under such an arrangement, some samples from majority class as well as most of the minority samples will be selected. The size of majority class will be reduced significantly in the selected samples. Further reduction can be achieved through sequential use of additional substages of such statistical tests on the selected subset data. The much-reduced data with much better balance between majority and minority then enter the second stage of the classification. In FIG. 1, first stage classification 100 is shown as the application of a function M1(X) producing a value compared 110 to the first threshold T1. If the function value is greater than or equal to the threshold, the sample X is declared good 120.

Here we give one possible embodiment of the first stage test. One skilled in the arts can construct other forms of statistical tests that achieve the similar goal. For example, fitting the multivariate normal (MVN) to the XGs:

1. Calculate the sample mean

$$μ = \frac{1}{{N}_{G}} {\sum }_{n = 1}^{{N}_{G}} {XG}_{n}$$

2. Calculate the sample covariance matrix

$${C}_{G} = \frac{1}{{N}_{G} - 1} {\sum }_{n = 1}^{{N}_{G}} ( {XG}_{n} - μ ) {( {XG}_{n} - μ )}^{T}$$

Invert the matrix to get

$${C}_{G}^{- 1} .$$

For reasons of numerical stability, straight inversion is rarely practical. A preferable approach is to estimate the inverse covariance matrix,

$${C}_{G}^{- 1}$$

using singular value decomposition.

3. Calculate the Mahalanobis distance for all XGs and XBs.

$$M ( X ) = {( X - μ )}^{T} {C}_{G}^{- 1} ( X - μ )$$

4. Choose a threshold, Th, for the first stage classifier. Various statistical means may be used to establish the threshold. If maximum defect sensitivity is required and one has a high degree of confidence in that defect samples in the training data are correctly labeled on may simply choose:

$$Th = {min}_{X ∈ XB} M ( X )$$

More typically, inaccurate labeling of some of the training samples must be considered. In this case, Th may be chosen to allow a small fraction of escapes.

5. Create the selected dataset X by taking all data with M(X)>=Th.

While the first-stage classifier has been shown as a single substage, multiple substages may be used in the first-stage classifier. Such an approach is useful where multiple substages may be used to further reduce the ratio of majority to minority class events.

Next, the second stage classifier is constructed. Many classification schemes may be applied to the selected data from the first stage classifier to obtain substantially better results.. Examples of classification schemes include but are not limited to: Boosted Classification Trees, Feed Forward Neural Networks, and Support Vector Machines. Classification Trees are taught, for example in Classification and Regression Trees, (1984) by Breiman, Friedman, Olshen and Stone, published by Wadsworth. Boosting is taught in Additive Logistic Regression: a Statistical View of Boosting, (1999) Technical Report, Stanford University, by Friedman, Hastie, and Tibshirani. Support Vector Machines are taught for example in “A tutorial on Support Vector Machines for pattern Recognition”, (1998) in Data Mining and Knowledge Discovery by Burges. Neural Networks are taught for example in Pattern Recognition and Neural Networks, B. D. Ripley, Cambridge University Press, 1996 or Neural Networks for Pattern Recognition, C. Bishop, Clarendon Press, 1995.

Boosted Classification Trees are presented as the preferred embodiment, although other classification schemes may be used. In the following description, the symbol “tree( )” stands for the subroutine for the classification tree scheme.

We use K-fold cross validation to estimate the predictive performance of classifier. Indices from 1 to K are randomly assigned to each sample. At iteration k, all samples with index k are considered validation data, while the remainder are considered training data.

1. Repeat for k=1, . . . , K:

(a) Sample X to obtain XT and XV, as described above, as training and validation data sets respectively

(b) Initialize weights ωᵢ=1/N_{T}, i=1, . . . , N_{T} for each training sample XT.

(c) Repeat for m=1,2, . . . , M:

i. Re-sample XTs with weights ωᵢ to create

XT′={XT′ₙ=1,2, . . . , N_{T }}

ii. Fit the tree( ) classifier with XT′, call it ƒₘ(x).

iii. Compute

$$err = {\sum }_{i = 1}^{{N}_{r}} {ω}_{i} 1 \{ {Y}_{i} \neq {f}_{m} ( {X}_{i} ) \}$$

where Yi are the true class labels. Let

cₘ=log[(1−err)/err]

iv. Update the weights

ω=ωᵢexp(cₘ*1{Yᵢ ≠ƒ(Xᵢ)})

and re-normalize so that Σωᵢ=1.

(d) Output trained classifier

$${f}_{k} ( x , t ) = 1 \{ {\sum }_{m = 1}^{M} {c}_{m} {f}_{m} ( x ) \geq t \}$$

where t is the threshold.

(e) Performance Tracking: Apply ƒₖ(x,t) to the validation set XV and compute the number of escapes, NEₖ(t), and number of false alarms, NFₖ(t) on this validation set for a large number (˜100) values of t covering the range of possible outputs.

K in the above description is typically chosen to be 10. M in the above description often ranges from 50 to 500. Choice of M is often determined empirically by selecting smallest M without impairing the classification performance, as described below.

2. Performance Estimation: compute the predicted performance of the classifier for various values of M in the range from 25 to 500:

$$\begin{matrix}E ( t ) = \frac{1}{{N}_{b}} {\sum }_{k = 1}^{K} {NE}_{k} ( t ) \\ F ( t ) = \frac{1}{{N}_{g}} {\sum }_{k = 1}^{K} {NF}_{k} ( t )\end{matrix}$$

Where N_{b} is the number of bad joints and N_{g} is the number of good joints in X respectively. One can then plot E(t) against F(t) for various values of t and M producing Operating Characteristic curves.

3. Assign values to the unit cost for escapes, Cₑ, and for false alarms, C_{f}. These values may be chosen by the user of the classifier.

4. Pick the optimal operating point The OC curve produces a set of potential candidate classifiers. The optimal \hat{t} is chosen to minimize overall cost, as

$$\hat{t} = arg {min}_{t} ( {C}_{e} * E ( t ) + {C}_{f} * F ( t ) )$$

or users can pick an operating point that fits their specification.

5. Repeat steps 1-4 for values of M ranging from 25 to 500. Choose a value, M* which yields optimal or nearly optimal cost at the chosen operating point. When several values of M yield similar performance, smaller values will typically be preferred for throughput.

6. Finally, train a classifier ƒ* using M* stages of boosting on the entire data set X. Classifer ƒ* will be deployed as the second stage of the hierarchical classifier, and will initially have its threshold set to the value selected at step 4 with M=M*.

In the hierarchical classifier so constructed, threshold t can be varied to generate predictable trade-offs between sensitivity and false alarm rate. As shown in FIG. 1, one embodiment of second stage classifier 200 applies 210 the data sample X to functions ƒ₁(X), ƒ₂(X), . . . , ƒₙ(X) and sums 220 the result with appropriate weight. Threshold t is shown as T2 in step 230 of second stage classifier 200. If the summed 220 value is greater than or equal to 230 this threshold, the sample X is declared defective 240, otherwise it is declared good 250. Varying threshold value t requires only that the second stage classifier be reevaluated with the new value of the threshold t. Retraining is not required. If new elements are added to the training data, however, either to the set of XG or of XB, then both first and second stage classifiers should be retrained.

Moderate changes in Cₑ or C_{f} can also be accommodated simply by changing the threshold so as to select the point on the operating characteristic which minimizes expected cost.

Just as the first-stage classifier may be taken as a single substage, or a set of substages in series, with the goal of reducing the ratio of majority to minority samples, the second-stage classifier may be taken as one or more substage operating in parallel as shown, or in series, each test identifying members of the minority class. The first stage-classifier, either a single or multiple cascaded substages, removes good (majority) samples with high reliability. The second-stage classifier, in single or multiple substages, recognizes bad (minority) samples.

The foregoing description of the present invention is provided for the purpose of illustration and is not intended to be exhaustive or to limit the invention to the precise embodiments disclosed. Accordingly the scope of the present invention is defined by the appended claims.

We claim:

1. A hierarchical classifier for classifying data samples into a first majority result class or a second minority result class, the hierarchical classifier comprising a first stage classifier which classifies input samples into the first result class, or passes the samples on to a second stage classifier which classifies samples from the first stage classifier into the first result class or the second result class.

2. A hierarchical classifier according to claim 1 where the first classifier removes most data samples which are members of the first majority input class by classifying those data samples as members of the first result class.

3. A hierarchical classifier according to claim 1 where the second classifier maps an input sample on to a value which is compared to a threshold value.

4. A hierarchical classifier according to claim 3 where the threshold value is adjustable.

5. A hierarchical classifier according to claim 1 where the first stage classifier comprises a single substage which classifies samples into the first result class or the second result class.

6. A hierarchical classifier according to claim 1 where the first stage classifier comprises a plurality of substages in series in which each substage classifies samples from the first stage classifier into the first result class or passes samples on to the next substage.

7. A hierarchical classifier according to claim 1 where the second stage classifier comprises a single substage which classifies samples from the first stage classifier into the first result class or the second result class.

8. A hierarchical classifier according to claim 1 where the second stage classifier comprises a plurality of substages which classify samples from the first stage classifier into the first result class or the second result class.

9. A hierarchical classifier according to claim 8 where the second plurality of substages are applied in series.

10. A hierarchical classifier according to claim 8 where the second plurality of tests are applied in parallel, each of the tests providing a weight which is summed to classify samples from the first stage classifier into the first result class or the second result class.

11. The method of training a hierarchical classifier for classifying data samples which are members of a first majority input class or a second minority input class into a first result class or a second result class comprising:
selecting a first classification model,
training the first model,
selecting a second classification model, and
training the second classification model.

12. The method of claim 11 where the step of training the second classification model includes the step of minimizing overall cost.

13. The method of claim 12 where cost parameters used in minimizing overall cost are specified by the user.

14. The method of claim 11 where the second classification model uses a threshold value.

15. The method of claim 14 where the threshold value used by the second classification model may be altered without retraining either the first or second stages.
